(19) United States
(12) Patent Application Publication
(10) Pub. No.: US 2010/0149067 A1
(43) Pub. Date: Jun. 17, 2010

(54) ANTENNA

(76) Inventors: Neil Williams, West Sussex (GB); Michael Philippakis, Surrey (GB); Dean Kemp, Surrey (GB)

Correspondence Address: REED SMITH LLP, P.O. BOX 488, PITTSBURGH, PA, 15230-0488, US

(21) Appl. No.: 12/528,795

(22) PCT Filed: Mar. 27, 2008
(86) PCT No.: PCT/GB2008/001067

§ 371 Date: Feb. 17, 2010

(30) Foreign Application Priority Data
Mar. 30, 2007 (GB) 0706327.4

(51) Int. Cl. H01Q 3/24

(52) U.S. Cl. 343/876

(57) ABSTRACT

A parasitic antenna element (20) comprises first and second switches: one at the base (PIN diode 22) and one approximately half way along the parasitic element (PIN diode 28). The lower half of the parasitic element is realized as a coplanar waveguide with a central conductor (32). This not only provides a convenient method for biasing the second PIN diode (28), but the outer conductors (24, 26) provide shielding and reduce coupling of the RF energy into the bias circuitry. The first switch located near the base of the antenna element is provided for selectively coupling the antenna element to a ground plane for quenching a first current mode. The second switch located along the antenna element selectively partitions the antenna element into first and second portions, thereby quenching higher order current modes.

The present invention relates to an antenna, for example an ultra-wideband antenna, and in particular to a parasitic antenna element for use in an antenna.

### BACKGROUND

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 per cent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a multi-band orthogonal frequency division multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organized into five band groups: four having three 528 MHz sub-bands, and one having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The basic timing structure of a UWB system is a superframe. A superframe consists of 256 medium access slots (MAS), where each MAS has a defined duration, for example 256 μs. Each superframe starts with a Beacon Period, which lasts one or more contiguous MASs. The start of the first MAS in the beacon period is known as the “beacon period start”.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc. home entertainment, such as televisions and devices that connect by wireless means, wireless speakers, etc.
communication between handheld devices and PCs, for example mobile phones and PDAs, digital cameras and MP3 players, etc.

Current UWB designs utilize omni-directional antennas. In future systems, which are targeted at very high data rate applications, there are benefits in using a number of higher gain elements, each of which covers a specific angular sector. Although travelling wave elements can be selected which offer the wide bandwidth required, an array of such elements is relatively large.

There is therefore a need for an antenna which can be easily adapted to radiate in a specific direction, and over a broad range of frequencies.

### SUMMARY OF INVENTION

According to a first aspect of the invention, there is provided a parasitic antenna element comprising: a first switch located near the base of the antenna element for selectively coupling the antenna element to a ground plane for quenching a first current mode; and a second switch located along the antenna element for selectively partitioning the antenna element into first and second portions, thereby quenching higher order current modes.

The parasitic antenna element has the advantage of being selectively reflective or transparent over a wide range of frequencies. Furthermore, the parasitic antenna element has the advantage of being low cost, since it may be printed on a PCB.

According to another aspect of the invention, there is provided an antenna array comprising at least one parasitic antenna element as defined in the appended claims.

### BRIEF DESCRIPTION OF THE DRAWINGS

For a better understanding of the present invention, and to show more clearly how it may be carried into effect, reference will now be made, by way of example, to the following drawings, in which:

FIG. 1 shows the multi-band OFDM alliance (MBOA) approved frequency spectrum of a MB-OFDM system;

FIG. 2 shows an antenna array;

FIG. 3 shows a parasitic antenna element;

FIGS. 4a and 4b are schematic diagrams showing current modes on a resonant monopole;

FIG. 5 shows a parasitic antenna element according to a first embodiment of the present invention; and

FIG. 6 shows a parasitic antenna element according to a second embodiment of the present invention.

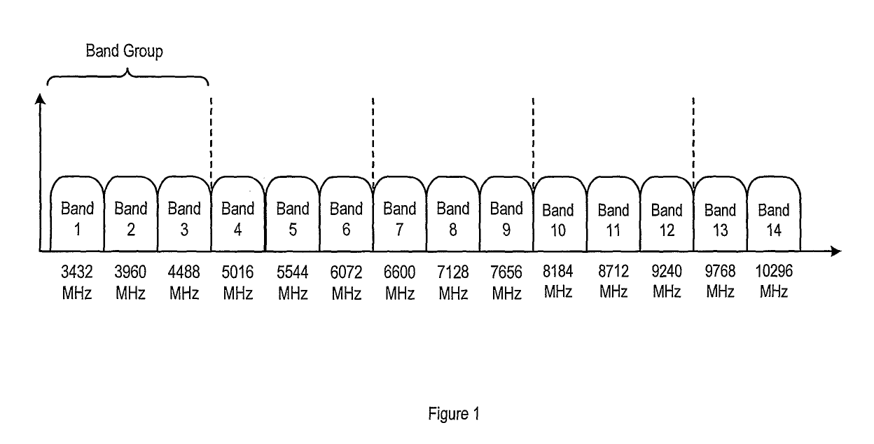

### DETAILED DESCRIPTION OF PREFERRED EMBODIMENTS

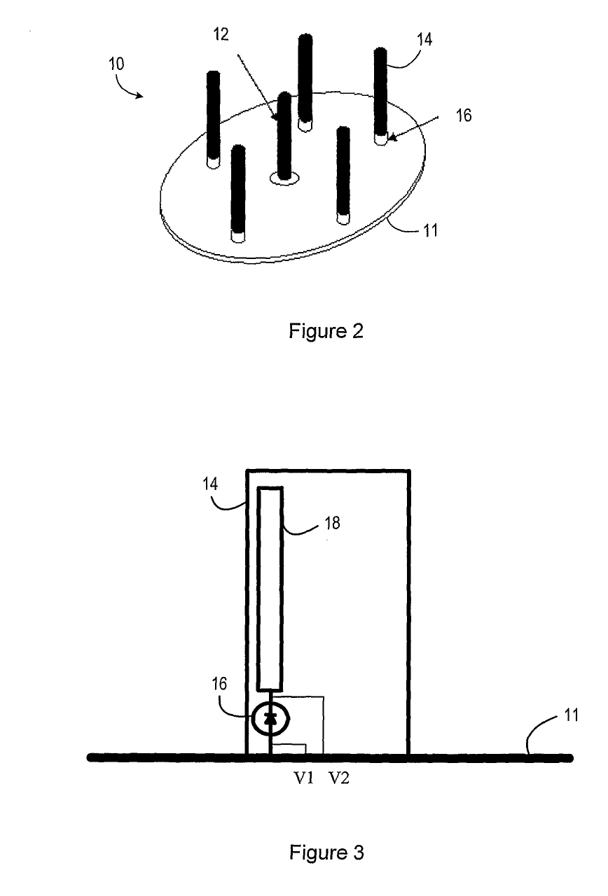

FIG. 2 shows an antenna array 10. The antenna array comprises a ground plane 11 with an omni-directional central radiating element 12. The omni-directional central radiating element 12 is surrounded by a plurality of parasitic elements 14, for example arranged in a ring formation. Although the radiating element 12 is omni-directional, one skilled in the art will appreciate that by appropriate biasing of the parasitic elements 14 the energy radiated by the central element 12 can be directed in specific sectors.

The biasing is achieved by providing a switch 16 at the base of each parasitic element 14.

FIG. 3 shows one of the parasitic elements 14 in more detail.

The parasitic element 14 comprises a monopole 18 on a printed circuit board (PCB). The monopole 18 is electrically connected to the ground plane 11 of the antenna array via a switch 16, for example a PIN diode. The PIN diode 16 is controlled by the application of control voltages V1 and V2.

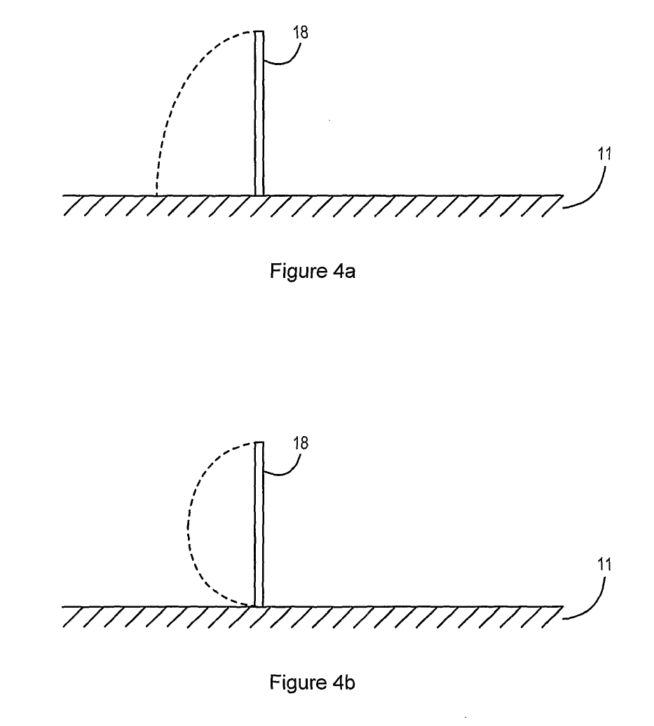

Thus, by opening and closing the switch 16, the monopole 18 can be made to reflect or be transparent to different frequencies. This is shown in more detail in FIGS. 4a and 4b.

FIG. 4a shows a monopole 18 connected to a ground plane 11, where the switch 16 (not shown) is closed. In this arrangement, the monopole 18 is highly reflective at frequencies close to the quarter-wave resonant frequency. This is illustrated by the dotted line in FIG. 4a. This behaviour relies on the fact that the element predominantly supports a single cosinusoidal current mode at quarter-wave resonance.

FIG. 4b shows the same monopole 18 connected to the ground plane 11, but where the switch 16 (not shown) is open. In this arrangement, although reflection of the quarter-wave resonance is quenched, thus making the monopole 18 transparent at such frequencies, the monopole 18 is highly reflective at much higher frequencies (for example twice the frequency of the resonant frequency in FIG. 4a when the switch 16 is closed, and other higher orders).

As can be seen from the above, the bandwidth offered by an antenna of this type is limited by the resonant nature of the parasitic elements; this affects their reflectivity and (more importantly) transparency characteristics.

The present invention allows quenching of the higher orders described with reference to FIG. 4b by providing a second switch along the monopole element.

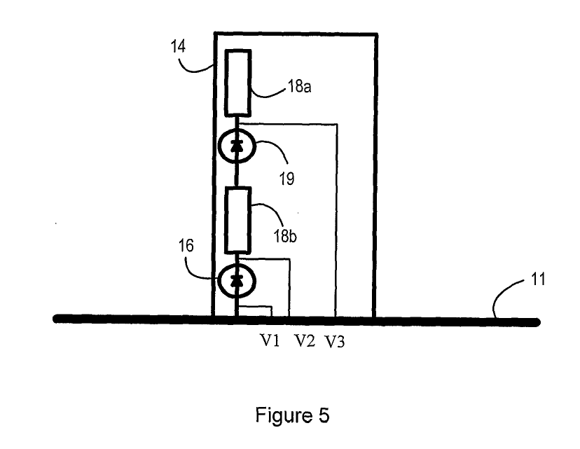

Referring to FIG. 5, in its basic form the invention comprises a second switch 19, which is controllable separately (i.e. using control signal V3) from the base switch 16 connecting the monopole 18 to the ground plane 11. The second switch 19 is provided, for example, approximately half way along the element 18. Thus, if both switches 16, 19 are open, not only will the quarter-wave frequency be quenched, but also the first higher order frequency (i.e. half-wave resonance).

Alternatively, the second switch 19 may be positioned at a different location along the antenna element 18. This will lead to different higher orders being quenched. The positioning of the second switch 19 is therefore chosen according to which frequencies need to be quenched.

It is noted that the bias element connecting the control signal V3 to the second switch 19 may be a wire having a high resistance, thereby reducing the coupling of RF currents into the control circuitry.

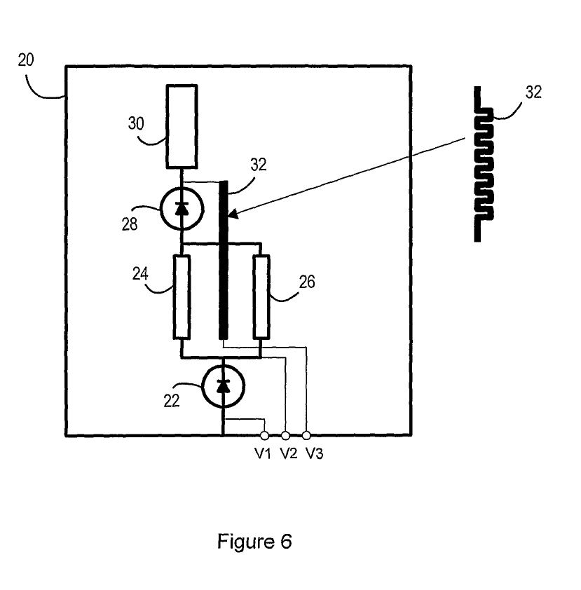

FIG. 6 shows a parasitic antenna element 20 according to a second embodiment of the present invention.

The element 20 comprises a first switch, for example a PIN diode 22, located near the base of the element, connecting the ground plane to two outer conductors 24, 26 connected in parallel. First and second control voltages V1 and V2 are applied to either side of the PIN diode 22 and thus control the switching of the PIN diode 22.

The two outer conductors 24, 26 connect to a second switch, for example a PIN diode 28. The second PIN diode 28 is connected in turn to a monopole element 30.

The antenna element 20 further comprises a central conductor 32 positioned between the two outer conductors 24, 26, such that the combination of the outer conductors 24, 26 and the central conductor 32 forms a coplanar waveguide. A third control voltage V3 is applied to the central conductor 32, one end of which is connected between the second PIN diode 28 and the monopole element 30, thus enabling the central conductor 32 to bias the second switch 28. In this way, the second PIN diode 28 can be controlled using the voltages V2 and V3. The coplanar waveguide has electrical characteristics that are similar to a short length of coaxial cable, and is designed such that the RF currents are primarily supported by the outer two conductors 24, 26, while the dc bias currents flow in the central conductor 32.

It can therefore be seen that the parasitic antenna element 20 has first and second switches: one at the base (PIN diode 22) and one approximately half way along the parasitic element (PIN diode 28). In this embodiment, the lower half of the parasitic element is realized as a coplanar waveguide with a central conductor 32. This not only provides a convenient method for biasing the second PIN diode 28, but the outer conductors 24, 26 provide shielding and reduce coupling of the RF energy into the bias circuitry. In other words, the bias signal V3 is protected from the RF signals radiating around the structure.

The central conductor 32 may be realized using a meander line 32 as the central conductor of the coplanar waveguide. The meander line 32 is preferably highly resistive. This has the effect of further reducing the coupling of the RF energy into the bias circuitry. Furthermore, the inductance of the meander line decouples the bias circuitry from the mid point of the antenna, thus eliminating any loading effect the bias may have on the performance of the antenna.

Although not shown in FIG. 6, it is noted that the bias element for the control voltage V2 may also incorporate a meander line and RF chokes to prevent coupling of the RF energy into the control signal V2. The RF chokes for the lower diode 22 may be provided by positioning the RF chokes below the ground plane. Similarly, a meander line and RF chokes may also be used with the bias element for the control voltage V1.

Although PIN diodes have been used to illustrate the switches throughout the description, one skilled in the art will appreciate that alternative switches could be used. For example, microelectromechanical systems (MEMS) switches or GaAs FET switches could be used as alternatives.

In operation, the parasitic antenna element will be provided as part of an antenna array substantially as described with reference to FIG. 2. That is, a central radiating element is surrounded by a ring of parasitic elements according to the present invention. These parasitic elements can be biased to be reflective or transparent over a broad range of frequencies and thus increase or decrease the strength of a signal in a certain direction. However, any antenna array comprising at least one parasitic element according to the present invention is to be considered within the scope of the invention.

There is therefore described a parasitic antenna element that is selectively reflective or transparent at a wide range of frequencies. This is accomplished by providing a first switch located near the base of the antenna element for selectively coupling the antenna element to a ground plane for quenching a first current mode, and a second switch located along the antenna element for selectively partitioning the antenna element into first and second portions, thereby quenching higher order current modes.

The antenna element is low cost, as it may be printed on a PCB. An antenna incorporating such parasitic antenna elements may be operated over an increased range of frequencies, and thus bandwidth. As such, the antenna element is particularly suited for use in ultra-wideband systems.

Although the preferred embodiment is described in relation to the parasitic element being switched between ground (to act as a reflector) and open circuit (to become transparent), it is noted that the parasitic element may also be switched to a signal source in order to act as a radiator.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A parasitic antenna element comprising:
a first switch located near the base of the antenna element for selectively coupling the antenna element to a ground plane for quenching a first current mode; and
a second switch located along the antenna element for selectively partitioning the antenna element into first and second portions, thereby quenching higher order current modes.

2. A parasitic antenna element as claimed in claim 1, wherein the second switch is located approximately half way along the antenna element, such that the first and second portions are substantially equal in length.

3. A parasitic antenna element as claimed in claim 1, wherein the first portion comprises a coplanar waveguide.

4. A parasitic antenna element as claimed in claim 3, wherein the coplanar waveguide comprises a central conductor for biasing the second switch.

5. A parasitic antenna element as claimed in claim 4, wherein the central conductor of the coplanar waveguide is highly resistive, thereby preventing RF energy from coupling with the central conductor.

6. A parasitic antenna element as claimed in claim 4, wherein the central conductor of the coplanar waveguide is inductive.

7. A parasitic antenna element as claimed in claim 4, wherein the central conductor of the coplanar waveguide is a meander line.

8. A parasitic antenna element as claimed in claim 1, wherein at least one of the first and second switches comprises a PIN diode.

9. A parasitic antenna element as claimed in claim 1, wherein at least one of the first and second switches comprises a microelectromechanical switch.

10. A parasitic antenna element as claimed in claim 1, wherein at least one of the first and second switches comprises a GaAs FET switch.

11. A parasitic antenna element as claimed in claim 1, wherein the first switch is controlled by first and second biasing voltages.

12. A parasitic antenna element as claimed in claim 11, wherein the second switch is controlled by the second biasing voltage and a third biasing voltage.

13. A parasitic antenna element as claimed in claim 12, wherein two or more of the bias voltages are connected to the first and second switches using meander lines.

14. A parasitic antenna element as claimed in claim 1, wherein the parasitic antenna element is printed on a printed circuit board.

15. An antenna array comprising:
at least one parasitic antenna element as claimed in claim 1.
